(19) United States
(12) Patent Application Publication
(10) Pub. No.: US 2002/0120649 A1
(43) Pub. Date: Aug. 29, 2002

(54) Embedding a description of a component-behavior model within a server page

(76) Inventor: Philip J. Goward, Portland, OR (US)

Correspondence Address: PARK, VAUGHAN & FLEMING LLP, 508 SECOND STREET, SUITE 201, DAVIS, CA, 95616, US

(21) Appl. No.: 09/792,462

(22) Filed: Feb. 23, 2001

(51) Int. Cl. G06F 15/00

(52) U.S. Cl. 707/513

(57) ABSTRACT

One embodiment of the present invention provides a system that facilitates embedding a description of a component-behavior model into a server page. The system operates by receiving a capsule containing a specification of the component-behavior model. This component-behavior model specifies components, which are separately deployable pieces of software that can be used to make up an application. It also specifies behaviors that define a response to an event, such as activating a component. Upon receiving the capsule, the system embeds the capsule into the server page to facilitate callbacks into the component-behavior model from within the server page. In this way, the component-behavior model can be utilized by executing the server page directly, without having to use a mechanism such as a servlet to facilitate use of the component-behavior model.

### BACKGROUND

1. Field of the Invention

The present invention relates to the process of designing applications for web sites on the Internet. More specifically, the present invention relates to a method and an apparatus for embedding a description of a component-behavior model into a server page.

2. Related Art

As the Internet continues to expand at an exponential rate, thousands of new web sites are coming on line every day selling products as diverse as books and automobiles, and offering services, such as stock trading and electronic banking. Unfortunately, deploying a web site of any sophistication can be an expensive and time-consuming task, requiring a large investment in expensive programmer time.

As web sites become more sophisticated, it is becoming increasingly common to provide web pages that perform computations and other functional operations in addition to simply displaying static information. This is often accomplished by executing “server pages,” which contain dynamically executable code in addition to static display language commands. For example, JAVA™ server pages (JSPs) are extensions to Java servlet technology, developed by SUN Microsystems, Inc. of Palo Alto, Calif. as an alternative to Active Server Pages (ASPs) developed by the Microsoft Corporation of Redmond, Wash. JSPs support dynamic scripting in addition to HyperText Markup Language (HTML) code.

There are a number of ways to execute a server page. A server page may be executed directly in response to receiving a uniform resource location (URL) from a web browser. This is the simplest way.

Alternatively, a server page can be executed under control of a servlet that executes on a web server. Note that a servlet is a program that runs on a server, and which can be executed by a web server or by another application on the server. Also note that a servlet is typically persistent, which means that once it is started it stays resident in memory, which allows a servlet to fulfill multiple requests from multiple applications.

One paradigm that is proving useful in developing applications, such as web sites, is the “component-behavior model” (also known as the “actor-behavior model”). The component-behavior model operates by linking programming components together through behaviors. A programming component is a separately deployable piece of software that can be used to make up an application. Moreover, a programming component typically has an interface defined by a component architecture, such as a JavaBean or a component model architecture (COM) object.

A behavior is a mechanism that generates a message (or series of messages) in response to an event. Note that a behavior can be used to link components together if the events received by the behavior are outputs of components and if the messages generated by the behavior cause method invocations within components.

By linking pre-existing components together to create an application, such as a web site, a large amount of programming time can be saved. Unfortunately, coordinating the execution of an application that is structured in this way can be a complicated task because a mechanism such as a servlet must typically be deployed to coordinate interactions between the components.

What is needed is a method and an apparatus that facilitates using the component-behavior model without the complications of using a mechanism such as a servlet to coordinate interactions between the components that are specified by the component-behavior model.

### SUMMARY

One embodiment of the present invention provides a system that facilitates embedding a description of a component-behavior model into a server page. The system operates by receiving a capsule containing a specification of the component-behavior model. This component-behavior model specifies components, which are separately deployable pieces of software that can be used to make up an application. It also specifies behaviors that define a response to an event, such as activating a component. Upon receiving the capsule, the system embeds the capsule into the server page to facilitate callbacks into the component-behavior model from within the server page. In this way, the component-behavior model can be utilized by executing the server page directly, without having to use a mechanism such as a servlet to facilitate use of the component-behavior model.

In one embodiment of the present invention, activating the component involves invoking a method defined by the component.

In one embodiment of the present invention, the system includes a callback into the capsule, wherein the callback invokes a method defined within the capsule.

In one embodiment of the present invention, the system loads the capsule from the server page and then compiles the capsule. Next, the system initializes components and behaviors defined within the capsule before executing the server page, wherein executing the server page involves making callbacks into methods defined within the capsule.

In one embodiment of the present invention, the callback triggers a second event that can trigger a behavior.

In one embodiment of the present invention, the capsule is embedded in Extensible Markup Language (XML) format within the server page.

In one embodiment of the present invention, the server page is a Java Server Page (JSP) or Active Server Page (ASP).

In one embodiment of the present invention, the components are JavaBeans.

In one embodiment of the present invention, receiving the capsule involves creating the capsule by receiving commands from a user who manipulates icons in a graphical user interface, and using the commands to create relationships between components and behaviors within the capsule.

In one embodiment of the present invention, embedding the capsule within the server page involves embedding the capsule within a server page tag.

### BRIEF DESCRIPTION OF THE FIGURES

FIG. 1 illustrates the architecture of a web server in accordance with an embodiment of the present invention.

FIG. 2 illustrates how a capsule containing a component-behavior model can be embedded within a server page in accordance with an embodiment of the present invention.

FIG. 3 presents a graphical representation of a capsule in accordance with an embodiment of the present invention.

FIG. 4 is a flow chart illustrating the process of creating a server page with an embedded capsule containing a component-behavior model in accordance with an embodiment of the present invention.

FIG. 5 is a flow chart illustrating the process of executing a capsule containing a component-behavior model that is embedded within a server page in accordance with an embodiment of the present invention.

FIG. 6 presents an exemplary Java Server Page including an embedded capsule in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Web Server

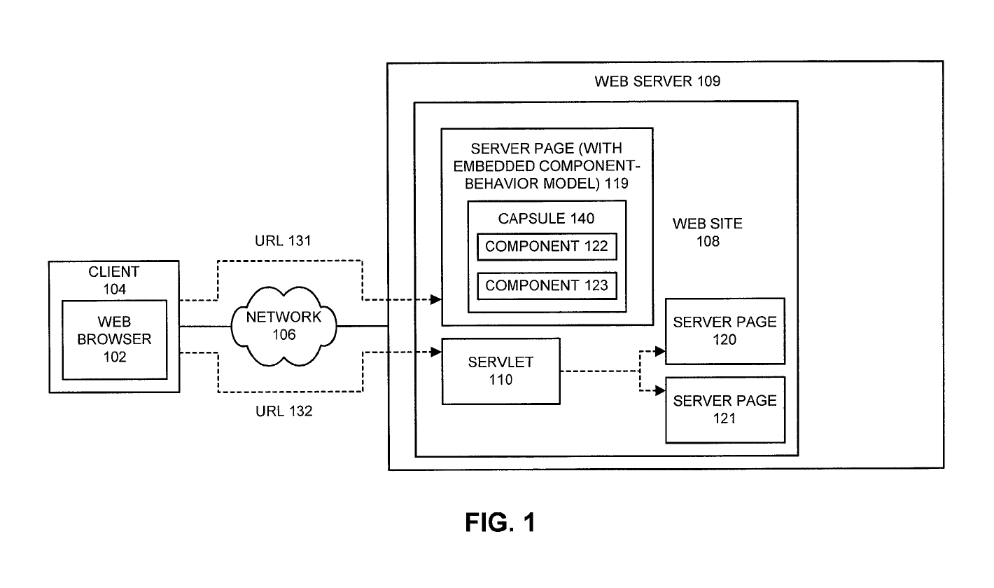

FIG. 1 illustrates a web server 109 in accordance with an embodiment of the present invention. In FIG. 1, a web browser 102 on client 104 communicates across network 106 with web site 108 on web server 109.

Client 104 can generally include any node on network 106 including computational capability and including a mechanism for communicating across network 106. Web browser 102 can generally include any type of web browser capable of viewing a web site, such as the INTERNET EXPLORER™ browser distributed by the Microsoft Corporation of Redmond, Washington.

Network 106 can generally include any type of wire or wireless communication channel capable of coupling together computing nodes. This includes, but is not limited to, a local area network, a wide area network, or a combination of networks. In one embodiment of the present invention, network 106 includes the Internet.

Web server 109 can generally include any computational node including a mechanism for servicing requests from a client for computational and/or data storage resources. Web server 109 hosts web site 108, which contains inter-linked pages of textual and graphical information that can be navigated through by a user operating web browser 102. Note that web site 108 contains a servlet 110. Servlet 110 is a program that runs on web server 109, and which can be executed by another application on web server 109.

Web browser 102 interacts with web site 108 by communicating uniform resource locators (URLs) 131-132 to web site 108. Web site 108 uses these URLs 131-132 to return web pages to web browser 102. In doing so, web site 108 makes use of server pages 119-121. As mentioned above, these server pages contain dynamically executable code in addition to static display language commands. Note that URL 131 causes server page 119 (which includes an embedded component-behavior model) to be executed directly. Executing server page 119 causes components 122 and 123 within embedded capsule 140 to be activated through the embedded component-behavior model.

Note that components 122 and 123 can include any type of local or distributed components, including JavaBeans (JBs), Enterprise JavaBeans (EJBs), Component Object Model (COM) objects, Distributed COM (DCOM) objects and Common Object Request Broker Architecture (CORBA) objects.

Also note that server pages can also be executed through a servlet. For example, URL 132 causes servlet 110 to be executed, and servlet 110 interacts with server pages 120-121. Note that servlet 110 may interact with a non-embedded component-behavior module (not shown) in order to activate components 122 and 123.

Embedded Capsule Containing Component Behavior Model

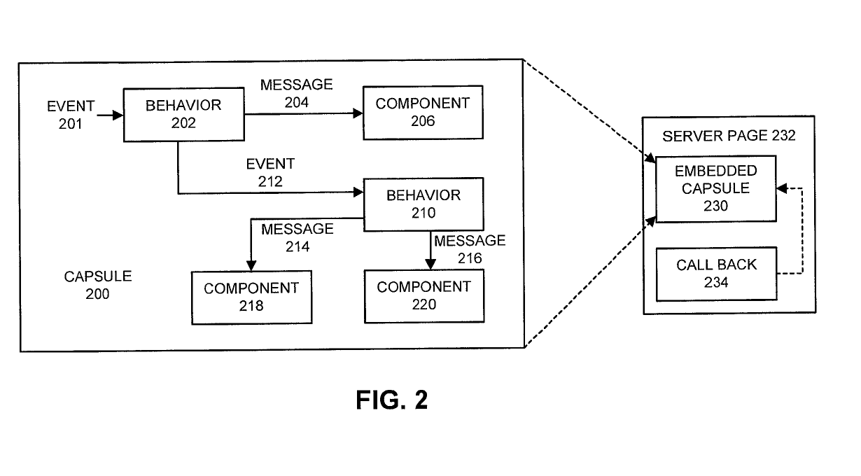

FIG. 2 illustrates how a capsule 200 containing a component-behavior model can be embedded within a server page 232 in accordance with an embodiment of the present invention.

Capsule 200 includes a number of inter-linked components (206, 218 and 220) and behaviors (202 and 210). Each of the behaviors 202 and 210 receives a stimulus in the form of an event 201 and 212, and generates a response in the form of one or more method invocations to the components 204, 214 and 216. (Note that an “event” is similar to an interrupt or a signal that is registered within the application.)

For example, a behavior 202 listens for an initial event 201, which may be generated through a callback into capsule 200. When initial event 201 occurs, behavior 202 sends a message 204 to component 206 by invoking a method defined within component 206. Behavior 202 may also generate an event 212 that feeds into another behavior 210.

Upon receiving event 212, behavior 210 executes a script that generates a number of messages 214 and 216. These messages 214 and 216 invoke methods within components 218 and 220.

In one embodiment of the present invention, capsule 200 is embedded into server page 232 in Extensible Markup Language (XML) form as embedded capsule 230. A callback 234 located within server page 232 is used to invoke a method defined within capsule 200.

Graphical Representation of Capsule

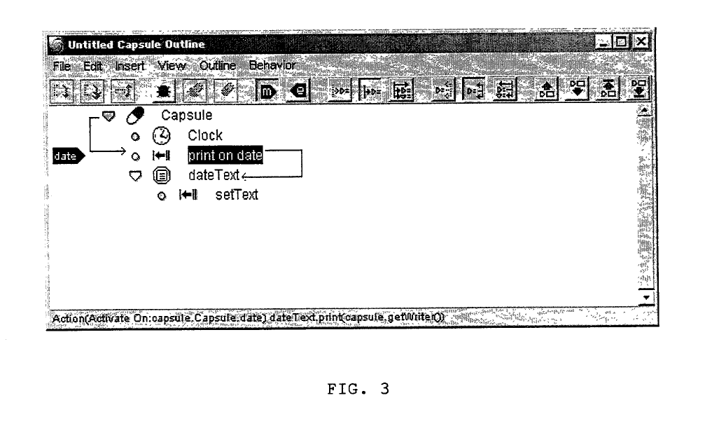

FIG. 3 presents a graphical representation of an exemplary capsule in accordance with an embodiment of the present invention. This graphical representation can be manipulated by entering commands through a graphical user interface.

Note that the graphical user interface appearing in FIG. 3 illustrates how a behavior, such as “print on date” is graphically linked to a component that causes a date to be outputted.

Process of Creating Server Page with Embedded Capsule

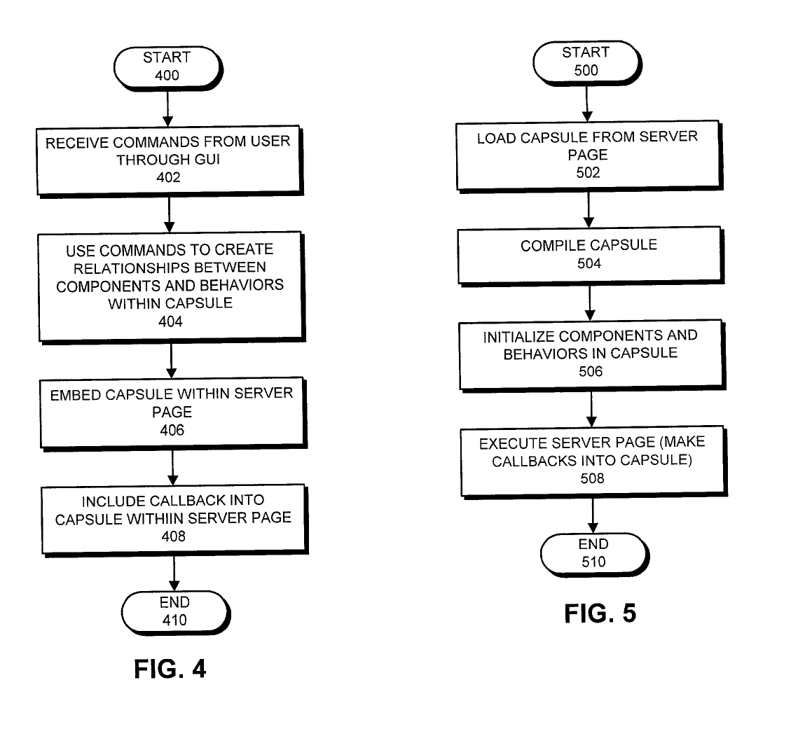

FIG. 4 is a flow chart illustrating the process of creating a server page 232 with an embedded capsule 230 containing a component-behavior model in accordance with an embodiment of the present invention. The system starts by receiving commands through a graphical user interface (GUI) (step 402), and then using these commands to create relationships between components and behaviors within capsule 200 (step 404). Next, once capsule 200 is created, the system embeds capsule 200 within server page 232 (step 406) by first converting the capsule 200 into XML form and then inserting capsule into server page 232 (step 408).

Process of Executing Embedded Capsule

FIG. 5 is a flow chart illustrating the process of executing a capsule 200 containing a component-behavior model that is embedded within a server page 232 in accordance with an embodiment of the present invention. As part of executing server page 232, the system first loads capsule 200 (step 502) and then compiles capsule 200 (step 504). Next, the system initializes the components and behaviors within the capsule (step 506). The result of performing these operations may be, for example, a Java class that can be utilized by code within server page 232.

Next, the system executes server page 232, which causes code within server page 232 to make callbacks into methods defined within capsule 200 (step 508).

### EXAMPLE JSP

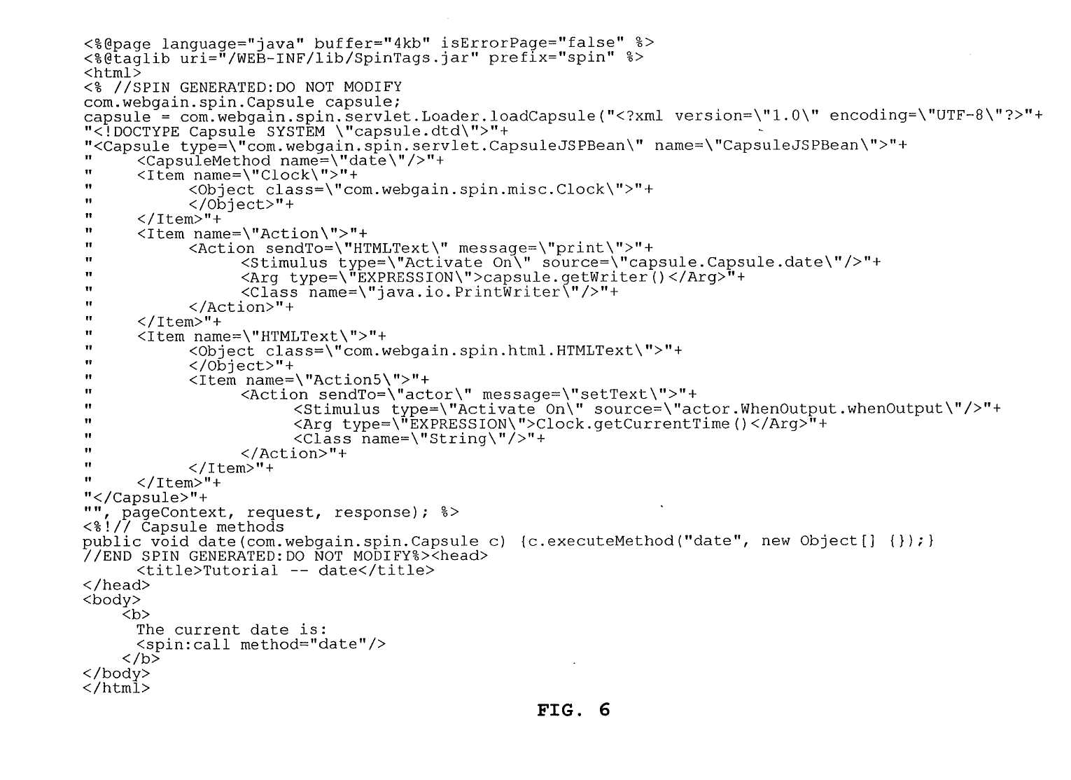

FIG. 6 presents an exemplary Java Server Page including an exemplary embedded capsule containing a component-behavior model in accordance with an embodiment of the present invention. This exemplary capsule contains a method “date” that includes a number of items including a “Clock” component and an “HTMLText” component, as well as an “Action” item that specifies a behavior. Upon receiving a specified stimulus, this behavior calls the method “print” defined within the component “HTMLText”.

Note that the method “date” is called from within the body of the server page through the callback “<spin:call method=”date“/>”.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for embedding a description of a component-behavior model into a server page, comprising:
receiving a capsule containing a specification of the component-behavior model;
wherein the component-behavior model specifies components, that are separately deployable pieces of software that can be used to make up an application;
wherein the component-behavior model also specifies behaviors that define a response to an event, wherein the response can include activating a component; and
embedding the capsule into the server page to facilitate callbacks into the component-behavior model from within the server page;
whereby the component-behavior model can be utilized by executing the server page.

2. The method of claim 1, wherein activating the component involves invoking a method defined by the component.

3. The method of claim 1, further comprising including a callback into the capsule from the server page, wherein the callback invokes a method defined within the capsule.

4. The method of claim 1, further comprising executing the server page by:
loading the capsule from the server page;
compiling the capsule;
initializing components and behaviors defined within the capsule; and
executing the server page, wherein executing the server page involves making callbacks into methods defined within the capsule.

5. The method of claim 4, wherein the callback triggers a second event that can trigger a behavior.

6. The method of claim 1, wherein the capsule is embedded in Extensible Markup Language (XML) format within the server page.

7. The method of claim 1, wherein the server page includes one of:
a Java Server Page (JSP); and
an Active Server Page (ASP).

8. The method of claim 1, wherein components are JavaBeans.

9. The method of claim 1, wherein receiving the capsule involves creating the capsule by:
receiving commands from a user who manipulates icons in a graphical user interface; and
using the commands to create relationships between components and behaviors within the capsule.

10. The method of claim 1, wherein embedding the capsule within the server page involves embedding the capsule within a server page tag.

11. A computer-readable storage medium storing instructions that when executed by a computer cause the computer to perform a method for embedding a description of a component-behavior model into a server page, the method comprising:
receiving a capsule containing a specification of the component-behavior model;
wherein the component-behavior model specifies components, that are separately deployable pieces of software that can be used to make up an application;
wherein the component-behavior model also specifies behaviors that define a response to an event, wherein the response can include activating a component; and
embedding the capsule into the server page to facilitate callbacks into the component-behavior model from within the server page;
whereby the component-behavior model can be utilized by executing the server page.

12. The computer-readable storage medium of claim 11, wherein activating the component involves invoking a method defined by the component.

13. The computer-readable storage medium of claim 11, wherein the method further comprises including a callback into the capsule from the server page, wherein the callback invokes a method defined within the capsule.

14. The computer-readable storage medium of claim 11, wherein the method further comprises executing the server page by:
loading the capsule from the server page;
compiling the capsule;
initializing components and behaviors defined within the capsule; and
executing the server page, wherein executing the server page involves making callbacks into methods defined within the capsule.

15. The computer-readable storage medium of claim 14, wherein the callback triggers a second event that can trigger a behavior.

16. The computer-readable storage medium of claim 11, wherein the capsule is embedded in Extensible Markup Language (XML) format within the server page.

17. The computer-readable storage medium of claim 11, wherein the server page includes one of:
a Java Server Page (JSP); and
an Active Server Page (ASP).

18. The computer-readable storage medium of claim 11, wherein components are JavaBeans.

19. The computer-readable storage medium of claim 11, wherein receiving the capsule involves creating the capsule by:
receiving commands from a user who manipulates icons in a graphical user interface; and
using the commands to create relationships between components and behaviors within the capsule.

20. The computer-readable storage medium of claim 11, wherein embedding the capsule within the server page involves embedding the capsule within a server page tag.

21. An apparatus that embeds a description of a component-behavior model into a server page, comprising:
a receiving mechanism that is configured to receive a capsule containing a specification of the component-behavior model;
wherein the component-behavior model specifies components, that are separately deployable pieces of software that can be used to make up an application;
wherein the component-behavior model also specifies behaviors that define a response to an event, wherein the response can include activating a component; and
an embedding mechanism that is configured to embed the capsule into the server page to facilitate callbacks into the component-behavior model from within the server page;
whereby the component-behavior model can be utilized by executing the server page.

22. The apparatus of claim 21, wherein activating the component involves invoking a method defined by the component.

23. The apparatus of claim 21, further comprising a callback establishment mechanism that is configured to include a callback into the capsule from the server page, wherein the callback invokes a method defined within the capsule.

24. The apparatus of claim 21, further comprising an execution mechanism that is configured to execute the server page by:
loading the capsule from the server page;
compiling the capsule;
initializing components and behaviors defined within the capsule; and
executing the server page, wherein executing the server page involves making callbacks into methods defined within the capsule.

25. The apparatus of claim 24, wherein the callback triggers a second event that can trigger a behavior.

26. The apparatus of claim 21, wherein the capsule is embedded in Extensible Markup Language (XML) format within the server page.

27. The apparatus of claim 21, wherein the server page includes one of:
a Java Server Page (JSP); and
an Active Server Page (ASP).

28. The apparatus of claim 21, wherein components are JavaBeans.

29. The apparatus of claim 21, wherein the receiving mechanism is configured to create the capsule by:
receiving commands from a user who manipulates icons in a graphical user interface; and
using the commands to create relationships between components and behaviors within the capsule.

30. The apparatus of claim 21, wherein the embedding mechanism is configured to embed the capsule within a server page tag.

31. A means for embedding a description of a component-behavior model into a server page, comprising:
a receiving means for receiving a capsule containing a specification of the component-behavior model;
wherein the component-behavior model specifies components, that are separately deployable pieces of software that can be used to make up an application;
wherein the component-behavior model also specifies behaviors that define a response to an event, wherein the response can include activating a component; and
an embedding means for embedding the capsule into the server page to facilitate callbacks into the component-behavior model from within the server page;
whereby the component-behavior model can be utilized by executing the server page.

32. A server page including an embedded description of a component-behavior model, comprising:
the server page; and
a capsule containing a specification of the component-behavior model embedded within the server page;
wherein the component-behavior model specifies components, that are separately deployable pieces of software that can be used to make up an application;
wherein the component-behavior model also specifies behaviors that define a response to an event, wherein the response can include activating a component;
whereby the component-behavior model can be utilized by executing the server page.

33. The server page of claim 32, further comprising a callback within the server page that calls a method defined within the capsule embedded in the server page.

34. The server page of claim 32, wherein the server page includes one of:
a Java Server Page (JSP); and
an Active Server Page (ASP).
